(19) United States
(12) Patent Application Publication
(10) Pub. No.: US 2005/0072349 A1
(43) Pub. Date: Apr. 7, 2005

(54) Tire pressure indicator

(76) Inventors: Mike Perlin, Orange Hill, CA (US); John I. Muri, Aliso Viejo, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/914,787

(22) Filed: Aug. 9, 2004

Related U.S. Application Data
(63) Continuation-in-part of application No. 29/191,803, filed on Oct. 13, 2003.
(60) Provisional application No. 60/493,507, filed on Aug. 8, 2003.

(51) Int. Cl. B60C 23/00

(52) U.S. Cl. 116/34 B; 340/442; 73/146

(57) ABSTRACT

Disclosed herein are embodiments of a tire pressure indicator (30) for providing indication of a tire's pressure. The indicator (30) may include first and second indicators (82, 104) corresponding to first and second ranges of tire pressures. The indicator (30) may also include a rolling diaphragm (58) that actuates display of the first or second indicators (82, 104). The indicator (30) may include a plurality of channels (78) that permit communication of air between an exterior portion of the indicator (30) and an interior portion of the indicator (30) and a filter (96) that permits air therethrough, but prevents moisture from passing therethrough.

### RELATED APPLICATIONS

This application claims priority of U.S. application Ser. No. 60/493,507, filed Aug. 8, 2003, entitled TIRE PRESSURE GAUGE, and is a continuation-in-part of U.S. application Ser. No. 29/191,803, filed Oct. 13, 2003, entitled PRESSURE GAUGE, both of which are incorporated herein in their entirety.

### BACKGROUND OF THE INVENTION

1. Field of the Invention

This invention relates generally to pressure indicators and, more particularly, to a tire pressure indicator for monitoring and indicating pressure inside vehicle tires.

2. Description of the Related Art

Maintaining the proper air pressure in pneumatic vehicle tires is critical for the safe and efficient operation of the tire as well as the vehicle as a whole. If such a tire is operated at air pressures below its recommended design pressure, the likely effects include substantially shortened life expectancy of the tires, dangerous impairment to road traction and steering control required for safe vehicle operation, and reduced overall vehicle fuel and mechanical efficiency.

The proper maintenance of tire pressure has and continues to be an unsolved problem for the vast majority of vehicle owners and operators. Manually checking the pressure of each tire on a regular basis is both a nuisance and inconvenience to the average vehicle operator. Typically, the majority of vehicle tires go unchecked and result in abnormal tire wear that is identified by visual observation or when the vehicle handling becomes noticeably impaired.

Various devices have been developed for providing a continuous and visible indication of tire operating pressure. Most of these devices either replace the standard tire valve stem or are a replacement for the original valve cap. However, most of these devices are either not accurate or are not able to withstand the environmental conditions (temperature extremes, extreme pressure excursions, moisture, contaminates, or striking, such as by rocks or other debris) to which tires are subject.

### SUMMARY OF THE INVENTION

The present invention involves several different embodiments related to a tire pressure indicator for monitoring and indicating pressure inside vehicle tires that provides accurate results and is able to operate for extended periods of time under the extreme operating conditions of tires.

The tire pressure indicator may indicate pressure by displaying a color visible through a pressure indicator window. The tire pressure indicator may also be adjusted so as to monitor and indicate correct pressure within a wide variety of different types of tires. For example, the tire pressure indicator may be used on the tires of motorbikes, automobiles, trucks, specialized vehicles such as airplanes, cranes, construction vehicles, as well as military vehicles.

In some embodiments, the tire pressure indicator permits fluid and gas communication between an interior portion of the indicator and the interior of the tire. When the tire is inflated, a pressure differential will exist between the interior of the tire and the interior portion of the indicator, causing air to flow from within the tire into a diaphragm chamber, formed from a rolling diaphragm, in the indicator. Increased pressure from the tire will cause the diaphragm to expand, providing indication of a range of tire pressures. As the pressure in the tire decreases, the diaphragm collapses, providing indication of another range of tire pressures.

In yet other embodiments, the indicator may include a first indicator that corresponds to a first range of tire pressures and a second indicator that corresponds to a second range of tire pressures. The indicator may also include a rolling diaphragm that actuates display of the first or second indicator.

In another embodiment, the tire pressure indicator may include a plurality of channels that permit communication of air between an exterior portion of the tire pressure indicator and an interior portion of the tire pressure indicator and to permit the pressure within the interior portion to adjust to the pressure of the exterior portion.

The indicator may also include a filter that permits air therethrough, but prevents moisture from passing therethrough. Accordingly, the indicator is able to maintain appropriate relation with atmospheric pressure while preventing corrosion or deterioration caused by moisture.

For purposes of summarizing the invention, certain embodiments, advantages, and novel features of the invention have been described herein. Of course, it is to be understood that not necessarily all such embodiments, advantages, or features are required in any particular embodiment of the invention and are not to be limited by the summary, but are set forth below in the Detailed Description of the Preferred Embodiments.

### BRIEF DESCRIPTION OF THE DRAWINGS

The features of the present invention which are believed to be novel are set forth with particularity in the claims. The invention, together with further objects and advantages thereof, may best be understood by making reference to the following description taken in conjunction with the accompanying drawings, in the figures of which like referenced numerals identify like elements, and wherein:

FIG. 1A is a perspective view of an embodiment of the tire pressure indicator.

FIG. 1B is a perspective view of another embodiment of the tire pressure indicator.

FIG. 2 is a side view of the tire pressure indicator of FIG. 1A.

FIG. 3 is a cross-sectional view of the tire pressure indicator of FIG. 2 along section 3-3.

FIG. 4 is a cross-sectional view of a tire pressure indicator with an expanded diaphragm coupled to a tire valve stem.

FIG. 5 is a cross-section view of a tire pressure indicator with a collapsed diaphragm coupled to a tire valve stem.

FIG. 6 is a perspective view of a diaphragm to be used with a tire pressure indicator.

FIG. 7 is a perspective view of a cap housing to be used with a tire pressure indicator.

FIG. 8 is a perspective view of a tire pressure indicator with a light dome on a posterior end of the indicator.

FIG. 9 is a cross-sectional view of the tire pressure indicator of FIG. 8.

FIG. 10 is a view of a wrench and a locking nut that may be used with the tire pressure indicator.

### DETAILED DESCRIPTION OF THE PREFERRED EMBODIMENTS

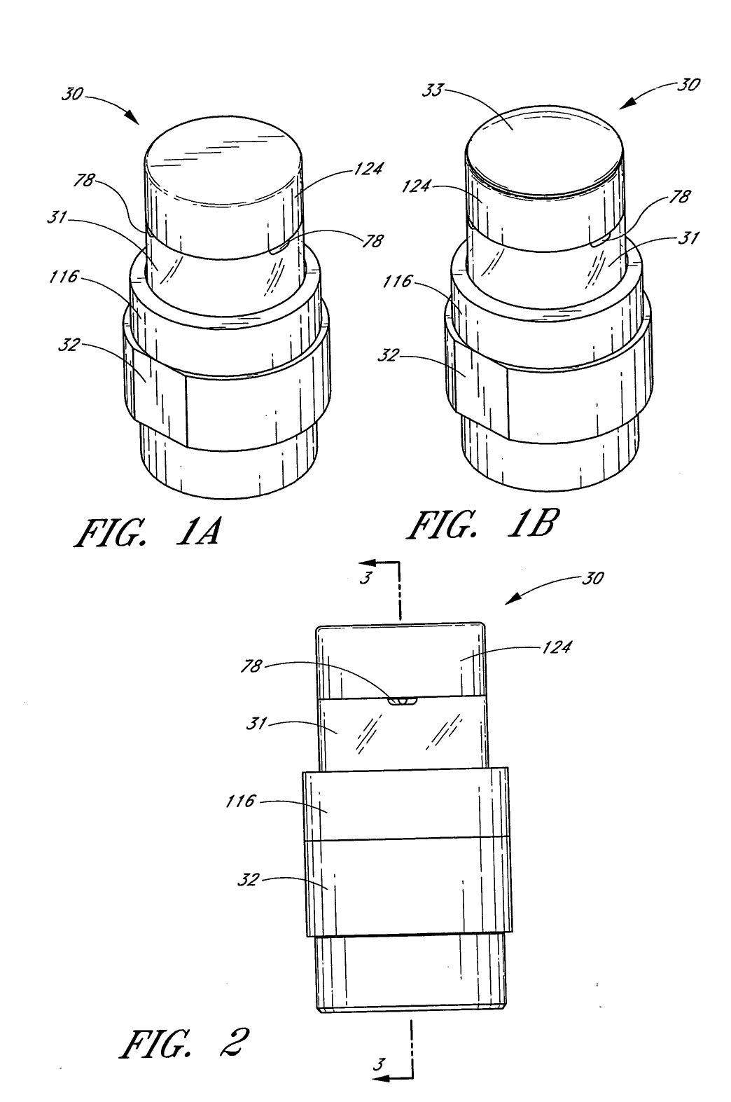

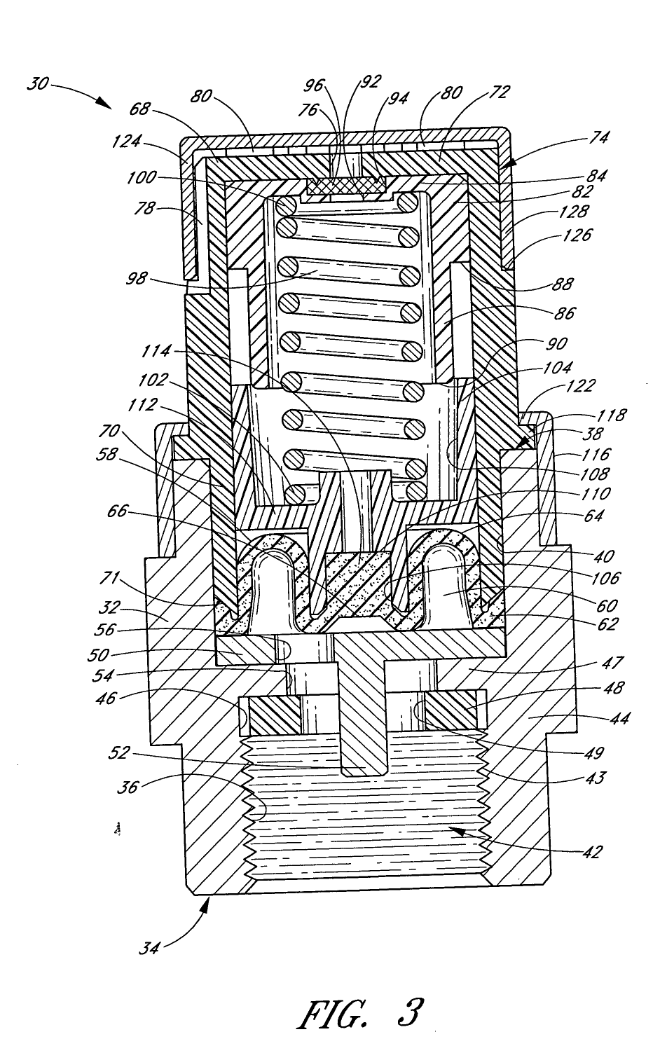

FIGS. 1A, 1B, and 2 illustrate embodiments of a tire pressure indicator 30 for monitoring and indicating pressure inside vehicle tires. The tire pressure indicator 30 may indicate pressure by displaying a color visible through a pressure indicator window. The tire pressure indicator 30 may also be adjusted so as to monitor and indicate correct pressure within a wide variety of different types of tires. For example, the tire pressure indicator 30 may be used on the tires of motorbikes, automobiles, trucks, specialized vehicles such as airplanes, cranes, construction vehicles, as well as military vehicles. In one embodiment, the tire pressure indicator 30 is adjustable for pressures ranging between 20 psi and 45 psi. In another embodiment, the tire pressure indicator 30 is adjustable for pressures ranging between about 14 psi and about 126 psi. In other embodiments, the tire pressure indicator 30 may be adjustable for pressure ranges substantially less than about 14 psi or substantially greater than about 126 psi.

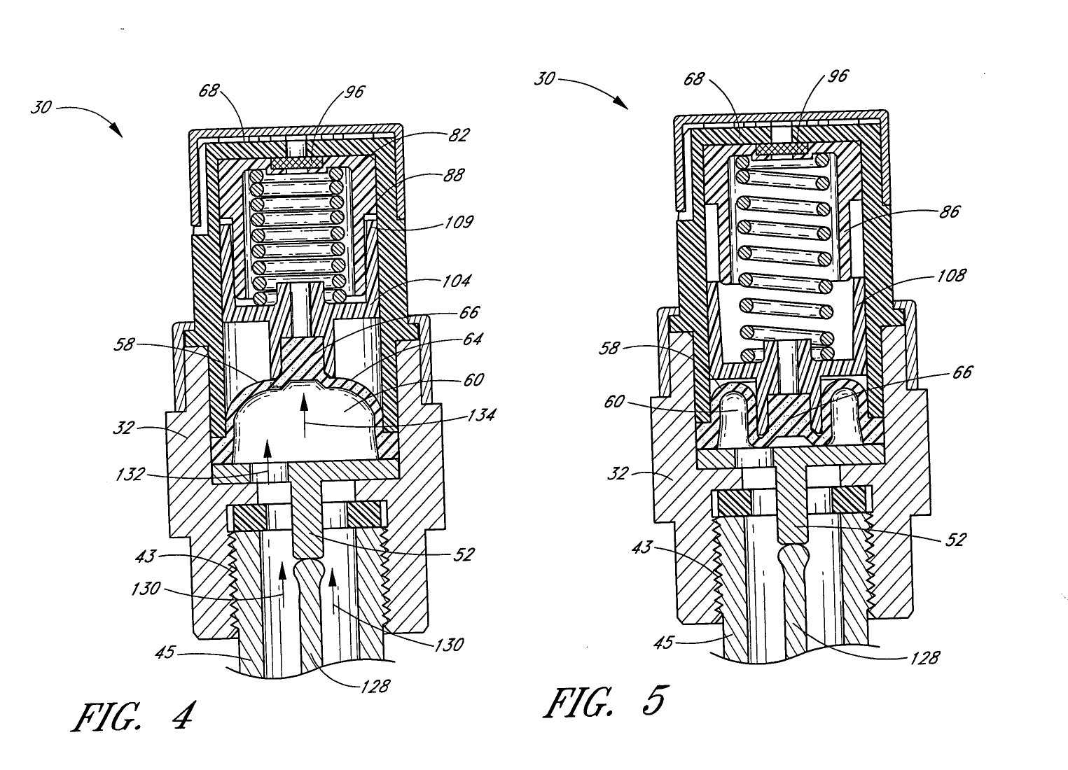

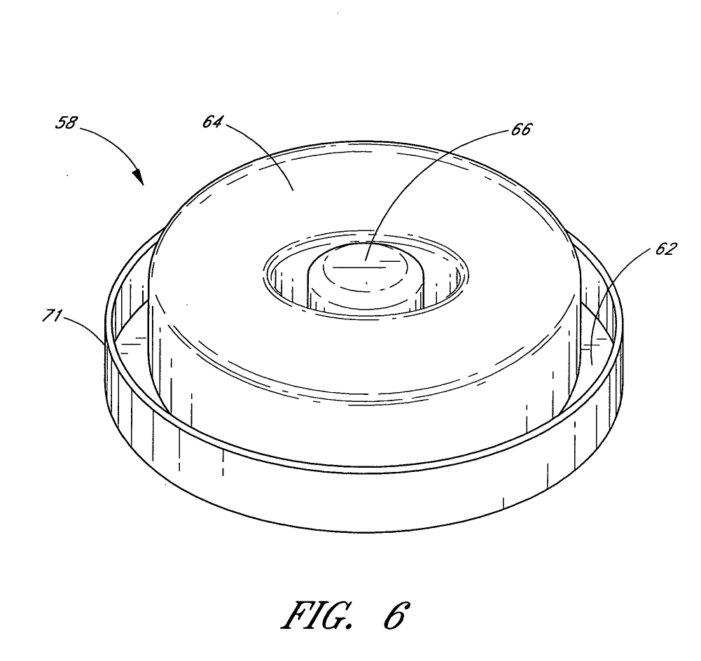

As shown in the illustrated embodiment of FIG. 3, the pressure indicator 30 preferably includes a screw housing 32. A first cylindrical bore 36 may be included on an anterior end 34 of the screw housing 32. On a posterior end 38 of the screw housing 32, the screw housing 32 may include a second cylindrical bore 40. On an interior portion 42 of the first cylindrical bore 36, the screw housing 32 preferably includes threads 43 to threadingly engage corresponding threads on a tire valve stem 45 (shown in FIGS. 4 and 5). The designations anterior, posterior, interior, or exterior, etc. are used above and herein only for descriptive purposes, and such designations are not intended to indicate any particular preferred orientation or configuration of the tire pressure indicator 30 or its components.

At a base 44 of the first cylindrical bore 36, the screw housing 32 preferably includes an interior cylindrical channel 46. The cylindrical channel 46 is preferably configured to permit placement therein of a seal 48. In one embodiment, the seal 48 operates to prevent air, or other gas, from escaping through the connection between the pressure indicator 30 and the tire valve stem 45. The seal 48 preferably includes a seal aperture 49 to permit passage of fluid or gas therethrough. The seal 48 may be made of silicone rubber or other suitable materials.

The second cylindrical bore 40 may include a base 47. The base 47 may be configured to permit placement thereon of a tire valve flange 50. The tire valve flange 50 preferably includes a tire valve flange pin 52 that extends anteriorly through the seal 48 and into the first cylindrical bore 36 through a screw housing aperture 54, which provides fluid communication between the first cylindrical bore 36 and the second cylindrical bore 40. The tire valve flange 50 also preferably includes an aperture 56 that preserves fluid communication between the first cylindrical bore 36 and second cylindrical bore 40 when the tire valve flange 50 is placed on the second cylindrical bore base 47. The screw housing 32 or the tire valve flange 50 may be made of aluminum, steel, or other suitable materials. In various embodiments, the screw housing 32 or the tire valve flange 50 may be formed, machined, molded, etc.

With reference to FIGS. 3 and 6, one embodiment of the pressure indicator 30 includes a diaphragm 58 that is configured to be placed within the second cylindrical bore 40 posteriorly of the tire valve flange 50. As illustrated, a rolling diaphragm 58 may be used to create a diaphragm chamber 60. A rolling diaphragm 58 may reduce the stretching of diaphragm material as tire pressure and temperature vary over time and may increase the accuracy and longevity of the diaphragm 58.

The diaphragm 58 may include a diaphragm base 62 that is configured to engage or be placed adjacent to a perimeter of the tire valve flange 50. The diaphragm 58 preferably extends posteriorly of the diaphragm base 62 to form a toroidal portion 64, which may assume the shape of a half-ring torus. In this embodiment, the diaphragm chamber 60 may be formed from the anteriorly-facing interior portion of the half-ring torus. The center of the toroidal portion 64 is preferably connected by a central portion 66 to prevent gas or fluid communication between the diaphragm chamber 60 and posteriorly of the diaphragm 58.

The diaphragm 58 operates to expand as the diaphragm chamber 60 is filled with fluid or air, as shown in FIG. 4. As the diaphragm 58 expands, the central portion 66 is displaced posteriorly, and the toroidal portion 64 is unrolled to permit expansion of the diaphragm 58. Controlled expansion of the diaphragm 58 may contribute to accuracy of the pressure indicator 30. When the diaphragm 58 contracts, as shown in FIG. 5, the central portion 66 is displaced anteriorly, and the toroidal portion 64 is rolled together to form a half-ring torus.

Although the rolling diaphragm 58 has been described as a half-ring torus, other toroidal shapes may also be used. Additionally, the rolling diaphragm 58 may be formed in shapes other than toroidal. The diaphragm 58 may be constructed of silicone, rubber, or other suitable materials.

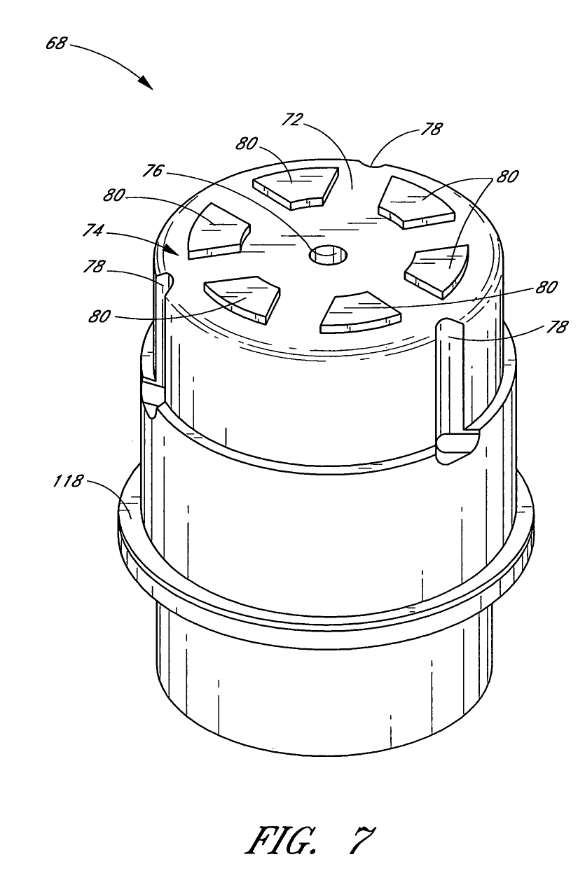

With reference to FIGS. 3 and 7, the pressure indicator 30 preferably includes a cap housing 68 that may assume a generally cylindrical shape. An anterior end 70 of the cap housing 68 may be configured to fit within the second cylindrical bore 40 and may be adjacent to the perimeter of the diaphragm base 62. In some embodiments, the anterior end 70 of the cap housing 68 may be configured to accommodate a diaphragm 58 peripheral ridge 71 (shown in FIGS. 3 and 6) extending posteriorly along the circumference of the diaphragm 58. The diaphragm's peripheral ridge 71 may extend posteriorly along the exterior of the anterior end 70 of the cap housing 68. In these configurations, the anterior end 70 of the cap housing 68 may operate to assist in securing the diaphragm base 62. The peripheral ridge may further assist to secure the diaphragm 58 and guide expansion of the diaphragm 58.

The cap housing 68 preferably includes a cap housing base 72 located on a posterior end 74 of the cap housing 68. The cap housing 68 also may include a cap housing aperture 76, which permits fluid communication between the interior and exterior of the cap housing 68. The cap housing 68 may include a plurality of peripheral channels 78 that extend along the posterior end of the cap housing 68. In one embodiment, the peripheral channels 78, or passageways, extend from a position anterior of the posterior end 74 and extend to the posterior end 74. On the posterior end 74, the cap housing 68 also may include posterior spacers 80 along the exterior of the cap housing base 72. The interior of the cap housing 68 provides an operating space in which other components may be disposed.

The cap housing 68 may be made of any suitable plastic, metal, combination thereof, or other materials. In one embodiment, the cap housing 68 is made of transparent polycarbonate. The cap housing may include a portion thereof consisting of either a transparent or translucent material to permit visual observation of components placed therein to provide indication of the tire pressure conditions. This portion may provide a pressure indicator window and may permit observation of different colors therethrough.

With continued reference to FIG. 3, a spring top 82 may be disposed at the posterior, interior portion of the cap housing 68, as illustrated in the embodiment of FIG. 1. The spring top 82 may include a spring top cylinder base 84 and an anteriorly-extending cylinder 86. The spring top 82 may also include an exterior circumferential rim 88 located posteriorly of the anterior cylinder end 90. The spring top cylinder base 84 also preferably includes a spring top aperture 92, which permits fluid or gas communication between the interior of the spring top cylinder and the cap housing aperture 76. The spring top 82 also preferably includes a posterior bore 94 that may be coaxial with the spring top aperture 92. The posterior bore 94 is preferably configured to permit placement therein of a filter 96 that may permit transmission of air therethrough, but preferably prevents fluid transmission therethrough.

The filter 96 operates as a vent and a moisture barrier between the interior of the cap housing 68 and the exterior of the tire pressure indicator 30. In one embodiment, the filter permits transmission of air therethrough, but prevents transmission of fluid or vapor therethrough. Accordingly, the filter maintains atmospheric pressure within the cap housing 68 of the tire pressure indicator 30, thereby allowing the pressure indicator 30 to respond accurately to changes in pressure inside the tire and with respect to atmospheric pressure. The moisture barrier prevents moisture from entering into the pressure indicator, and may greatly extend reliability and operating life of the tire pressure indicator 30.

In one embodiment, the spring top 82 encapsulates a portion of a spring 98 that extends anteriorly of the spring top cylinder base 84 toward the diaphragm 58. A posterior end 100 of the spring 98 preferably engages the spring top cylinder base 84 while an anterior end 102 of the spring 98 preferably engages a spring base 104.

As illustrated in FIG. 3, the spring base 104 may include an anterior cylinder 106 and a posterior cylinder 108. The anterior cylinder 106 may also include an anterior cylinder base 110, and the posterior cylinder 108 may include a posterior cylinder base 112. The anterior cylinder 106 is preferably configured to permit coupling to the diaphragm central portion 66, with a posteriorly-extending portion 114 of the central portion 66 extending through the anterior cylinder 106 to engage the anterior cylinder base 110. The posterior cylinder 108 is configured to slidingly encapsulate the anteriorly-facing spring top cylinder 86. In this embodiment, the spring base 104 is slidingly disposed within the cap housing 68, and the spring base 104 is opposed posteriorly by the spring 98 and anteriorly by the diaphragm 58.

In one embodiment, the cap housing 68 is coupled to the screw housing 32 via a secure ring 116 that is press fitted to couple the two pieces together. In this embodiment, the cap housing 68 may include an anterior circumferential rim 118 that is configured to engage a screw housing posterior end 38, as illustrated in FIG. 3. The secure ring 116 may include a posterior lip 122 that is configured to secure the cap housing 68 to the screw housing 32 via the anterior circumferential rim 118.

The secure ring 116 may include a “weak point” that will permit the secure ring to release the coupling of the cap housing 68 and the screw housing 32 if broken. In another embodiment, the cap housing 68 may include the weak point, wherein if the weak point is broken, the coupling between the cap housing 68 and screw housing 32 is also broken. The weak point may allow the posterior portion of the tire pressure indicator 30, including the cap housing 68 and the components located within both the cap housing 68 and the screw housing 32, to break free of the screw housing 32 if the cap housing 68 is damaged, such as by collision with road debris, a rock, a curb, or other road hazard. The weak point permits the various internal components of the tire pressure indicator 30 to be expelled, thereby preventing the tire from deflating. The weak point may be an area of reduced thickness in material or an area that is otherwise easily broken upon impact or trauma.

The tire pressure indicator 30 also preferably includes a cap 124 that is to be placed over the posterior end 74 of the cap housing 68. The cap housing may include a posterior circumferential rim 126 to abut an anterior end 127 of the cap 124. The peripheral channels 78 of the cap housing 68 preferably extend anteriorly of the anterior end 127 of the cap 124 when the cap 124 is placed on the cap housing 68, as shown in FIGS. 1A, 1B, and 2. The peripheral channels may permit fluid and gas communication between the exterior of the tire pressure indicator 30 and the cap housing aperture 76. The posterior spacers 80 of the cap housing 68 may permit separation between the posterior end 74 of the cap housing 68 and the cap 124, permitting gas or fluid therein. In one embodiment, the cap housing 68 may include one peripheral channel 78, while in other embodiments a plurality of peripheral channels 78 may be provided. It may be advantageous to have a plurality of peripheral channels 78 to permit alternative paths for air to pass in the event one of the channels become clogged with dirt or debris.

In operation, the tire pressure indicator 30 is threadingly coupled to the tire valve stem 45 by the threads 43 on the interior portion 42 of the screw housing 32, as shown in FIGS. 4 and 5. The tire valve flange pin 52 engages a tire valve stem pin 128 to permit fluid communication between the interior portion 42 of the screw housing 32 and the interior of the tire. When the tire is inflated, a pressure differential will exist between the interior of the tire and the interior portion 42 of the screw housing 32, causing air to flow from within the tire into the pressure indicator 30, .as indicated by arrows 130. In such circumstances, air from the tire will be transferred through the interior 42 of the screw housing 32 through the seal aperture 49, the screw housing aperture 54, the tire valve flange aperture 56, and into the diaphragm chamber 60, as indicated by arrow 132. The increased pressure within the diaphragm chamber 60 will cause the diaphragm 58 to expand, as indicated by arrow 134, exerting a posterior force on the spring base 104. The posterior force of the diaphragm 58 will be opposed by the spring 98. When the posterior force of the diaphragm 58 is greater than the resistance force of the spring 98, the spring base 104 will displace posteriorly to permit expansion of the diaphragm chamber 60, until either the resistance force of the spring 98 is equal to the posterior force of the diaphragm 58 or a posterior cylinder posterior end 109 of the spring base 104 engages the exterior circumferential rim 88 of the spring top 82.

As the pressure in the tire decreases, the force from the spring will cause anterior displacement of the spring base 104 and will expose the spring top cylinder 86 as the posterior cylinder posterior end 109 of the spring base 104 is also displaced anteriorly. When the cap housing 68 is made of a transparent or translucent material, the spring top cylinder 86 will be visible as the spring base posterior cylinder 108 is displaced anteriorly. Accordingly, in one embodiment, the spring base posterior cylinder 108 may be made of a green material, and the spring top cylinder 86 may be made of a red material. In this embodiment, when the spring base posterior cylinder 108 is displaced posteriorly, the green material will be visible from the exterior of the tire pressure indicator 30, indicating the pressure within the tire is at least at an acceptable level. When the spring base 104 is displaced anteriorly, the red spring top cylinder 86 may be visible from the exterior of the tire pressure indicator 30 through the transparent or translucent cap housing 68, indicating the pressure within the tire has fallen below an acceptable level.

As shown in FIG. 8, in one embodiment, the exterior of the screw housing may include a portion 136 configured to permit placement thereon or inscription therein of the pressure ranges for which the particular tire pressure indicator 30 is intended to be operated. In one embodiment, the interior portion 42 of the screw housing 32 has a diameter of about 0.307 inches. In some embodiments, the inner portion 42 diameter may range between about 0.25 inches and about 0.5 inches. In other embodiments, the interior portion 42 diameter may be significantly less than about 0.25 inches or significantly greater than about 0.5 inches. The length of the cylinder of the first cylindrical bore 36 may be about 2.45 inches, although in other embodiments, the length of the first cylindrical bore 36 may range from about 0.15 inches to about 0.3 inches. In other embodiments, the length of the first cylindrical bore 36 may be significantly less than 0.15 inches or significantly greater than 0.3 inches.

The second cylindrical bore 40 of the screw housing 32 may have a diameter of about 0.36 inches. In some embodiments, the diameter of the second cylindrical bore 40 may range between about 0.3 inches and about 0.5 inches, and in other embodiments, the diameter of the second cylindrical bore 40 may be significantly less than about 0.3 inches or significantly greater than about 0.5 inches. The length of the second cylindrical bore 40 may be about 0.255 inches, or in other embodiments, the length may be between about 0.2 inches and about 0.4 inches. In yet other embodiments, the length of the second cylindrical bore 40 may be significantly less than about 0.2 inches or significantly greater than about 0.4 inches.

The tire valve flange 50 is configured to be disposed at the second cylindrical bore base 47. The tire valve flange 50 may consist of a disk having a diameter substantially the same as that of the second cylindrical bore 40. In one embodiment, the tire valve flange 50 has a diameter of about 0.357 inches, and in other embodiments, the tire valve flange 50 diameter may range from about 0.25 inches to about 0.5 inches. In yet other embodiments, the tire valve flange may have a diameter substantially less than about 0.25 inches or substantially greater than about 0.5 inches.

The tire valve flange 50 preferably includes a tire valve flange pin 52 that, when placed in the second cylindrical bore 40, extends anteriorly of the screw housing aperture 54 into the first cylindrical bore 36. The tire valve flange pin 52 is preferably configured to engage the tire valve stem pin to prevent fluid and gas communication between the first cylindrical bore and the tire. The tire valve flange 50 preferably includes an aperture 56 to permit transmission of air or fluid therethrough. In one embodiment, the tire valve flange aperture may consist of a cylindrical bore through the tire valve flange 50. In one embodiment, the tire valve flange pin 52 is located in the center of the tire valve flange 50, and the tire valve flange aperture 56 may be offset from the center.

The spring base 104 is preferably configured to be slidably disposed within the cap housing 68. The anterior cylinder 106 of the spring base 104 may have a diameter of about 0.079 inches, and in other embodiments, the diameter may range from about 0.05 inches to about 0.1 inch. In further embodiments, the diameter of the anterior cylinder 106 may be substantially less than about 0.05 inches or substantially greater than about 0.1 inch. The posterior cylinder 108 of the spring base 104 may have a diameter of about 0.26 inches in one embodiment, and in other embodiments, the diameter of the posterior cylinder 106 may range from about 0.2 inches to about 0.5 inches. In yet other embodiments, the diameter of the posterior cylinder 108 may be significantly less than about 0.2 inches or significantly greater than about 0.5 inches. In one embodiment, the diameter of the posterior cylinder 108 of the spring base 104 may increase as the cylinder extends from the posterior cylinder base 112 to the posterior cylinder posterior end 109. This may facilitate slideability of the spring base 104 over the spring top cylinder 86. The posterior cylinder base 112 may include a groove or a protrusion that will assist in aligning the spring 98 within the cap housing 68.

The spring top cylinder 86 may be made from plastic, such as polycarbonate, or other suitable materials. The spring top cylinder 86 may have a diameter of about 0.208 inches. In other embodiments, the spring top cylinder 86 may have a diameter of between about 0.15 inches and about 0.5 inches. In yet other embodiments, the spring top cylinder 86 may have a diameter that is substantially less than about 0.15 inches or substantially greater than about 0.5 inches. The length of the spring top cylinder 86 may be about 0.26 inches. In some embodiments, the spring top cylinder length may be between about 0.2 inches and about 0.5 inches. In one embodiment, the spring top cylinder may be significantly less than about 0.2 inches or significantly greater than about 0.5 inches.

The posterior bore 94 of the spring top 82 may have a diameter of about 0.1 inch, and in other embodiments, the posterior bore 94 may have a diameter of between about 0.75 inches and about 0.2 inches. In yet other embodiments, the posterior bore 94 may have a diameter that is substantially less than about 0.75 inches or substantially greater than about 0.2 inches. The spring top aperture 92 may have a diameter of about 0.04 inches in one embodiment, or in other embodiments, the spring top aperture 92 may have a diameter of between about 0.02 inches and about 0.05 inches. In yet other embodiments, the spring top aperture 92 may have a diameter of significantly less than about 0.02 inches or significantly greater than about 0.05 inches. The posterior bore 94 is configured to permit placement therein of the filter 96.

The filter 96 is preferably made of a material that will permit transmission therethrough of oxygen and nitrogen, but will prevent water vapor from passing therethrough. The filter 96 may be made of a polytetrafluroethylene membrane such as one made by Porex Corporation, called porex hydrophobic sheet.

The cap housing 68 may be made of a transparent material, such as polycarbonate plastic, or other plastics, or glass. In other embodiments, the cap housing 68 may be made of multiple materials, with a portion of the cap housing 68 including a transparent window. The cap housing 68 may have a cylindrical shape, wherein the diameter of the cylinder is about 0.3 inches. In other embodiments, the diameter of the cylinder may range from about 0.15 inches to about 0.5 inches, and in yet other embodiments, the cylinder may have a diameter substantially less than 0.15 inches or substantially greater than about 0.5 inches. The cylinder may have a length of about 0.525 inches in one embodiment, or in other embodiments, the cylinder length may range from about 0.3 inches to about 0.75 inches. In yet other embodiments, the cylinder length may be significantly less than about 0.3 inches or significantly greater than about 0.75 inches.

While the tire pressure indicator 30 has been described herein as assuming generally a cylindrical shape, and the separate components also having generally cylindrical shapes, it is contemplated that the tire pressure indicator 30 and its components may assume a triangular, rectangular, pentagonal, hexagonal, irregular, etc. shape. It is also contemplated that several of the internal components of the tire pressure indicator 30 may be reversed, inverted, or interchanged, and assume other configurations.

The pressure indicator 30 disclosed herein may also be use in applications not related to tires. For example, the pressure indicator 30 may be used in industrial and commercial applications. An example of a commercial application is use in an airplane cabin to monitor pressure therein. In industry, for example, the indicator 30 may be used in a steam line to monitor pressure. Those of ordinary skill in the art recognize various other applications to which the pressure indicator 30 may be applied.

In some embodiments, the tire pressure indicator 30 may include an electronic pressure indicator coupled to an electronic or mechanical pressure indicator, or an RF transmitter that sends signals to a receiver inside the vehicle when the tire is at a desired pressure range. Alternatively, the signal from the RF transmitter may be sent when the tire pressure is at an undesirable pressure range. The receiver preferably includes electronic components that interpret the received signals as tire pressure values and then displays these values inside the vehicle cabin. This enables the operator of the vehicle to visually monitor the tire pressure while operating the vehicle. This feature may be particularly suitable for use on vehicles wherein tire pressure is important to the safe operation of the vehicle.

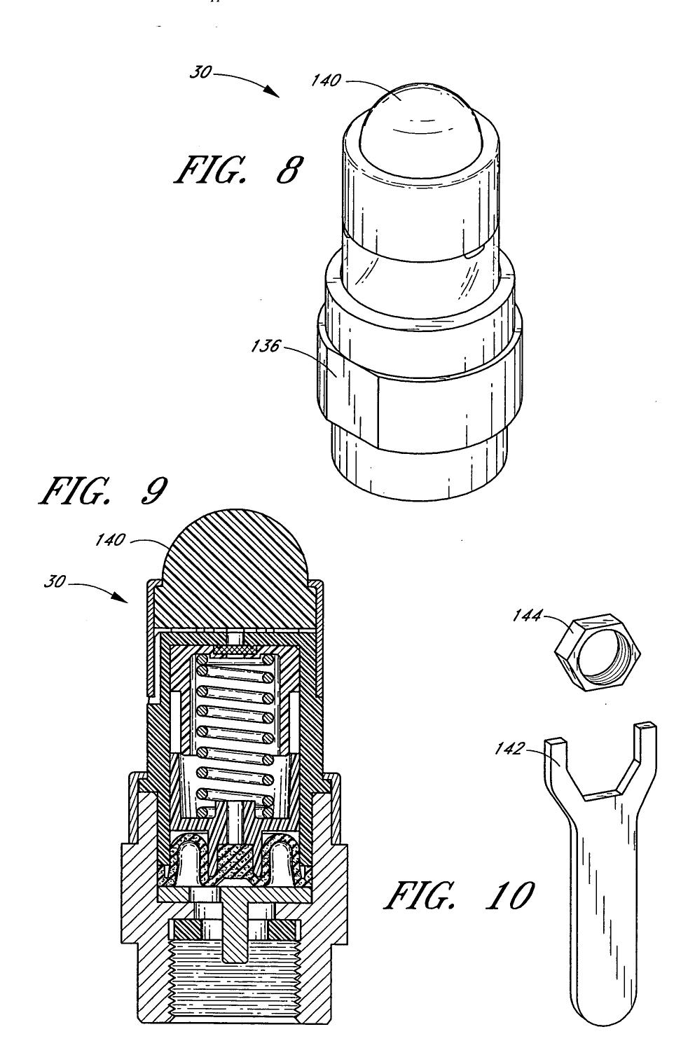

In some embodiments, as illustrated in FIGS. 8 and 9, a light dome 140 may be fastened to the top of the tire pressure indicator 30 by a securing nut, adhesive, or other attachment means. The light dome 140 can be configured to illuminate while the vehicle is in motion. The light dome 140 may also be configured to illuminate when the vehicle is at rest. The light dome 140 may operate independent of the tire pressure indicator, allowing the tire pressure indicator to continue to monitor and indicate pressure within the tire. Alternatively, the light dome 140 may be configured to illuminate on demand when a user pushes or generally touches the light dome 140. In yet another embodiment, the light dome 140 may be configured to illuminate when the pressure in the tire reaches an undesirable range. In some embodiments, the light dome 140 may be removably attached to the tire pressure indicator 30, allowing for removal and replacement of the light dome 140.

In one embodiment, the light can be configured to display different colors depending on the pressure inside the tire. Thus, the light dome 140 may function as a pressure indicator, in addition to the indicators described herein. In yet other embodiments, the light dome 140 may be configured to attach to the vehicle tire stem 45 without the need of attaching to the tire pressure indicator 30. This will permit the light dome 140 to operate without the presence of the pressure indicator 30. The light dome 140 can be configured to display different colors while the vehicle is moving. The light dome 140 may be powered by batteries or piezo-electric crystals, wherein a force on the crystal creates electricity to illuminate the light dome 140.

With reference to FIG. 10, a wrench 142 and locking nut 144 may be provided to prevent the tire pressure indicator 30 from being easily removed from the tire stem 45 by hand. The locking nut 144 is generally installed onto the tire stem 45 before the tire pressure indicator 30, and then back-torqued against the anterior end 34 of the screw housing 32. This locks the tire pressure indicator 30 in position on the tire stem 45. In some embodiments, the wrench 142 and locking nuts 144 may be provided with a set of tire pressure indicators 30, while in other embodiments, the wrench 142 and locking nuts 144 may be provided separately.

As shown in FIG. 1B, the cap 124 may have an exterior surface that permits placement thereon of a dome 33, or attachment. The dome 33 may be used for purposes of company or personal identification (logos), or the dome 33 may operate as a light dome 140. The dome 33 may be attached by adhesive or by other appropriate means. For example, in some embodiments, the dome 33 may be manufactured with the cap 124 and coupled with the cap 124 before distribution. The shape of the dome may be spherical, orthogonal, irregular, etc.

Although this tire pressure indicator 30 has been disclosed in the context of certain preferred embodiments and examples, it will be understood by those skilled in the art that the pressure indicator 30 extends beyond the specifically disclosed embodiments to other alternative embodiments and/or uses of the pressure indicator 30 and obvious modifications and equivalence thereof. In addition, while a number of variations of the pressure indicator 30 have been shown and described in detail, other modifications, which are within the scope of this pressure indicator 30, will be readily apparent to those of skill in the art based upon the disclosure. It is also contemplated that various combinations or subcombinations of the specific features and aspects of the embodiments may be made and still fall within the scope of the pressure indicator 30. Accordingly, it should be understood that various features and aspects of the disclosed embodiments can be combined with or substituted for one another in order to form varying modes of the disclosed pressure indicator 30. Thus, it is intended that the scope of the pressure indicator 30 herein disclosed should not be limited by the particular disclosed embodiments described above, but should be determined only by a fair reading of the claims that follow.

1. A tire pressure indicator configured to provide indication of a tire's pressure, the tire pressure comprising:
a first housing portion with threads configured to threadingly couple to the valve stem of a tire;
a second housing portion configured to be secured to the first portion and comprising a transparent portion, the second housing portion further comprising a hollow interior and at least two passageways to permit the transfer of fluid between an interior and an exterior of the second housing portion;
a first indicator that is displayed when the tire's pressure corresponds to a first tire pressure;
a second indicator that is displayed when the tire's pressure corresponds to a second tire pressure; and
a rolling diaphragm that changes the location of the first and second indicators relative to each other;
wherein a change in air pressure from the tire results in the rolling diaphragm changing shape.

2. The pressure indicator of claim 1, further comprising a spring that opposes expansion of the rolling diaphragm.

3. The pressure indicator of claim 1, wherein the rolling diaphragm is toroidal when collapsed.

4. The pressure indicator of claim 1, wherein the second indicator is configured to be displayed when the diaphragm is expanded.

5. The pressure indicator of claim 1, further comprising a filter that is configured to prevent fluids from entering the hollow portion of the second housing portion.

6. The pressure indicator of claim 1, further comprising a light dome.

7. The pressure indicator of claim 1, wherein the pressure indicator is configured to prevent air from leaking from the tire when the pressure indicator is damaged.

8. A tire pressure indicator configured to provide indication of a tire's pressure, the tire pressure indicator comprising:
a first indicator that corresponds to a first range of tire pressures;
a second indicator that corresponds to a second range of tire pressures; and
a rolling diaphragm that actuates display of the first or second indicator.

9. The pressure indicator of claim 8, wherein the rolling diaphragm is toroidal.

10. The pressure indicator of claim 8, wherein the rolling diaphragm is configured to unroll as it expands.

11. The pressure indicator of claim 8, wherein the rolling diaphragm is configured to slidably actuate the second indicator.

12. The pressure indicator of claim 8, wherein actuation of the first or second indicator is configured to be opposed by a spring.

13. The pressure indicator of claim 8, further comprising a plurality of pathways from an exterior portion of the pressure indicator to an interior portion of the pressure indicator to permit pressure equilibrium between the exterior and interior portions.

14. The pressure indicator of claim 8, further comprising a hydrophobic filter.

15. The pressure indicator of claim 8, wherein the first and second indicators are mechanically displayed.

16. The pressure indicator of claim 8, wherein the pressure indicator is configured to prevent air loss from the tire if the pressure indicator is damaged.

17. The pressure indicator of claim 8, further comprising a light dome.

18. The pressure indicator of claim 8, further comprising an identification attachment.

19. The pressure indicator of claim 1, further comprising an identification attachment.

20. A tire pressure indicator comprising a plurality of passages that permit communication of air between an exterior portion of the tire pressure indicator and an interior portion of the tire pressure indicator and to permit the pressure within the interior portion to adjust to the pressure of the exterior portion.
